(19) United States
(12) Patent Application Publication
(10) Pub. No.: US 2026/0262607 A1
(43) Pub. Date: Sep. 10, 2026

(54) BALL-SHAPED CAT TREAT FEEDER AND INTERACTIVE WAND TOY

(71) Applicant: Redhead Innovations LLC, Spokane, WA (US)

(72) Inventor: Dallas Taylor Maupin, Vancouver, WA (US)

(21) Appl. No.: 19/071,817

(22) Filed: Mar. 6, 2025

(51) Int. Cl. A01K 15/02

(52) U.S. Cl. CPC A01K 15/0201; A01K 15/0257

(57) ABSTRACT

A ball-shaped pet treat feeder and an interactive pet wand toy utilizing the ball-shaped pet treat feeder are provided. The wand toy includes the pet treat feeder formed using a pair of hollow members. One of the hollow members includes opening(s) for dispending pet treats or releasing aroma from the attractants loaded inside the pet treat feeder. Further, the wand toy includes a wand and a cord. An end of the cord is coupled to an end of the wand and the other end of the cord is coupled to a cord engagement provision located on one of the hollow members. The opening(s) facilitates the random dropping of the treats or releasing aroma from the attractant placed inside the feeder as the pet treat feeder spherical ball is rolled along a surface or swung in the air by a pet owner using the wand.

### FIELD OF THE INVENTION

The present invention relates to the field of pet feeders and pet wand toys, and more particularly, the present invention relates to a ball-shaped pet treat feeder that stimulates a pet's, especially a cat's, natural hunting or food grabbing instincts by rolling on a surface for dispensing treats and releasing aroma from attractants such as catnip or other herbs, and be attached to a wand so that the feeder ball can be controlled by a pet owner to play with the pet.

### BACKGROUND

Pets usually spend much of their time indoors. These pets tend to become lethargic and often do not undergo sufficient exercise and lack enjoyment until brought outdoors, which usually does not even occur for certain animals like cats. While having healthy and happy pets is an objective of every pet owner, the ability of pet owners to exercise and play with their pets is sometimes limited due to a lack of time and energy. For that reason, numerous toys are available to entertain and cause the pet to be more active and exercise. Many toys are adapted to allow a cat to track and chase a target. A few examples of such toys include K-berho™, PetSafe™, The PomPom Rattle Cat Toy, Fur Mice Cat Toys, Look Who's Talking® For Cats, and Mesh Ball Cat Toys.

Further, most pets also tend to become more excited about an activity that involves obtaining treats or food. For that reason, a number of inventions have been devised that relate to encouraging activity while dispensing such pet treats, for example, U.S. Pat. No. 2,086,631 describes a toy in the form of a spherical body with a cavity to store catnip or other herbs, and a duct for dispensing the catnip to a surface of the toy, as well as a closure means for closing the duct.

U.S. Pat. No. 8,904,967 discloses a pet toy treat dispenser and method wherein treats are dispensed from openings that may be of different sizes and that are located at different locations and orientations on the toy.

U.S. Pat. No. 10,932,443 discloses a pet treat dispenser and method of dispensing treats wherein animal interaction with the dispenser controls the amount and rate at which treats are dispensed.

U.S. Pat. No. 6,237,538 discloses a pet toy ball feeder. The feeder is formed using two hollow hemispherical halves, which may be releasably joined together to permit storing of pet treats therein. The pet treats are dispensed through one or more openings that are slightly larger than the pet treats for random dropping of the treats through the one or more openings.

U.S. Pat. No. 10,524,453 describes a treat dispensing pet toy in which treats are dispensed by differential movement between complementary elements of the pet toy resulting in variable dispensing rates.

U.S. Pat. No. 6,073,581 describes a ball-like toy that includes a spherical shell and a cylindrical valve, the spherical shell being formed of two symmetrical half shells. The half shells have ribs and partition boards, the cylindrical valve being mounted in a hole on the spherical shell and retained between the ribs and partition boards of the half shells. When the toy is rotated within a limited angle, dog food is discharged out of the spherical shell through the cylindrical valve when the spherical shell is rolled on the ground.

Some of these treat feeder toys serve the desired purpose but can't be opened up for cleaning from the inside. Further, some of these treat feeder toys can accommodate different-sized treats, but none have the ability to get attached to a wand to create an interactive toy that can be controlled by a pet owner.

Although a number of treat dispensing pet toys exist, there is still a need to provide a ball-shaped treat feeder or treat feeding wand toy that can better stimulate a pet to achieve extended play and interaction with the toy. There is also a need to provide a treat feeder ball or treat feeding wand toy that is robust enough to withstand contact by the pet, but is relatively simple in construction and thus be produced economically. There is also a need to provide the treat feeder ball that may dispense treats at different rates.

### SUMMARY

An object of the present invention is to provide a modular ball-shaped pet treat feeder that's able to roll over a surface and dispense treats out and be attached to a wand controllable by a pet owner. The ball-shaped treat feeder can dispense or control the amount and rate at which treats are dispensed based on the shape and size of the openings dispensing treats.

An object of the present invention is to provide a cat treat feeder ball attachable to a wand forming an interactive wand feeder toy. The wand toy configuration satisfies pet's natural instincts by engaging in hunting-like behaviors in a safe and controlled environment. The wand toy also provides exercise, helping pets (cats) burn off excess energy and maintain a healthy weight. Additionally, the pet wand play promotes mental stimulation, preventing boredom and potential behavior issues.

An object of the present invention is to provide a pet treat feeder that's ball-shaped and allows the feeder to roll on a surface when rolled by a pet or a pet owner for dispensing treats through at least one opening provided on the feeder.

An object of the present invention is to provide a ball-shaped pet treat feeder and/or interactive wand toy using the feeder that may be filled with attractants such as catnip or herbs for releasing an aroma that might attract the pet to play with the feeder.

An object of the present invention is to provide substantially ball-shaped cat treat feeder and an interactive wand toy that is durable and lightweight and can be readily assembled.

According to an aspect of the present invention there is provided a ball-shaped pet treat feeder and interactive wand toy. The ball-shaped pet treat feeder includes a first hollow member, and a second hollow member openably attachable to the first hollow member. The feeder is capable of holding at least pet treats, or attractants therein. The second hollow member comprising at least one opening to facilitate at least one of: random dropping of the pet treats or releasing aroma from the attractants placed inside the ball-shaped pet treat feeder as the ball-shaped pet treat feeder is rolled along a surface by a pet and/or a pet owner or swung on the air by the pet owner. The first hollow member comprises a cord engagement provision adapted for releasably connecting the ball-shaped pet treat feeder to a wand such that the pet owner can interactively play with the pet holding the wand.

According to another aspect of the present invention, there is provided an interactive pet wand toy. The interactive pet wand toy includes a ball-shaped pet treat feeder comprising a first hollow member, a second hollow member openably attachable to the first hollow member and comprising at least one opening. The pet wand toy includes a wand comprising a first end, and a second end. The pet wand toy further includes a cord with a proximal end, and a distal end. The proximal end of the cord is coupled to the first end of the wand and the distal end of the cord is coupled to a cord engagement provision located on the first hollow member. The at least one opening facilitates at least one of: random dropping of pet treats or releasing aroma from attractants placed inside the ball-shaped pet treat feeder as the ball-shaped pet treat feeder is rolled along a surface by a pet or swung on the air by a pet owner grasping the wand.

According to another aspect of the present invention, there is provided a method of dispensing treats or releasing aroma from a ball-shaped pet treat feeder and interactive wand toy. The method includes providing, the ball-shaped pet treat feeder that includes a first hollow member, a second hollow member openably attachable to the first hollow member. The second hollow member comprising at least one opening. The method further comprising loading, pet treats or attractants within the ball-shaped pet treat feeder. The method further includes providing the ball-shaped pet treat feeder that can be rolled along a surface by a pet and/or a pet owner or swung in the air by the pet owner. The method further includes dispensing of the pet treats or releasing aroma from the attractants placed inside pet treat feeder through the at least one opening located second hollow member.

These and other features and advantages of the present invention will become apparent from the detailed description below, in light of the accompanying drawings.

### BRIEF DESCRIPTION OF THE DRAWINGS

For a more complete understanding of the disclosure, reference should be made to the following detailed description and accompanying drawing figures, in which like reference numerals identify like elements in the figures.

FIG. 1 illustrates a perspective view of a ball-shaped pet treat feeder, in accordance with an embodiment of the present disclosure.

FIG. 2 illustrates an exploded view of the pet treat feeder of FIG. 1.

FIG. 3 illustrates a perspective view of a ball-shaped pet treat feeder, in accordance with another embodiment of the present disclosure.

FIG. 4 illustrates an exploded view of the pet treat feeder of FIG. 3.

FIG. 5 illustrates a perspective view of a pet feeder holding attractant such as catnip or similar herbs, in accordance with another embodiment of the present disclosure.

FIG. 6 illustrates an exploded view of the pet feeder holding the attractant shown in FIG. 5.

FIGS. 7-8 depicts the pet treat feeder of FIGS. 1 and 3 in interactive use in accordance with an embodiment of the present invention;

FIG. 9 depicts the pet feeder of FIG. 5 in interactive use in accordance with an embodiment of the present invention;

FIGS. 10-12 depicts the pet feeders of FIGS. 1, 3, 5 according to other embodiments in which the pet feeders are shown in a configuration connectable to a wand that can be hand held by a pet owner.

FIG. 13 depicts the pet feeder ball of FIG. 5 holding attractant according to another embodiment in which the feeder is configured to connect to a wand.

FIG. 14 shows an interactive wand toy with the pet feeder ball of FIG. 5, according to an embodiment.

FIGS. 15 and 16 show an interactive wand toy with the pet feeder ball of FIGS. 1 and 3 respectively, according to an embodiment.

FIGS. 17 and 18 depict the interactive wand toy of FIG. 14 or FIG. 15 or FIG. 16 in use.

While the disclosed pet toys and methods are susceptible of embodiments in various forms, there are illustrated in the drawings (and will hereafter be described) specific embodiments of the disclosure, with the understanding that the disclosure is intended to be illustrative and is not intended to limit the disclosure to the specific embodiments described and illustrated herein.

### DETAILED DESCRIPTION

The following description is of exemplary embodiments of the invention only and is not intended to limit the scope, applicability, or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, attachment mechanisms and the like and still fall within the scope of the present invention. Thus, the detailed description herein is presented for purposes of illustration only and not for limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

The present disclosure is provided to solve problems inherent in the existing prior arts. The disclosure provides novel pet treat feeders (specifically ball-shaped) and interactive wand toys having unique designs and features as will be described in the description to follow. Specifically, the present disclosure provides a pet wand toy with a ball-shaped pet feeder providing different playing functionality to keep the pet engaged. A pet wand toy according to the present disclosure may include a wand with two ends, a cord coupled to a first end of the wand and a second end coupled to a member of the ball-shaped pet treat feeder. In a first configuration, the ball-shaped pet feeder may alone be launched on the floor to dispense treats and keep the pet engaged without any need to hold the wand. In a second configuration, the ball-shaped pet feeder may be coupled to the wand using the cord and the wand may be held by the pet owner to play with the pet as will be described in the description below with respect to the accompanying drawings.

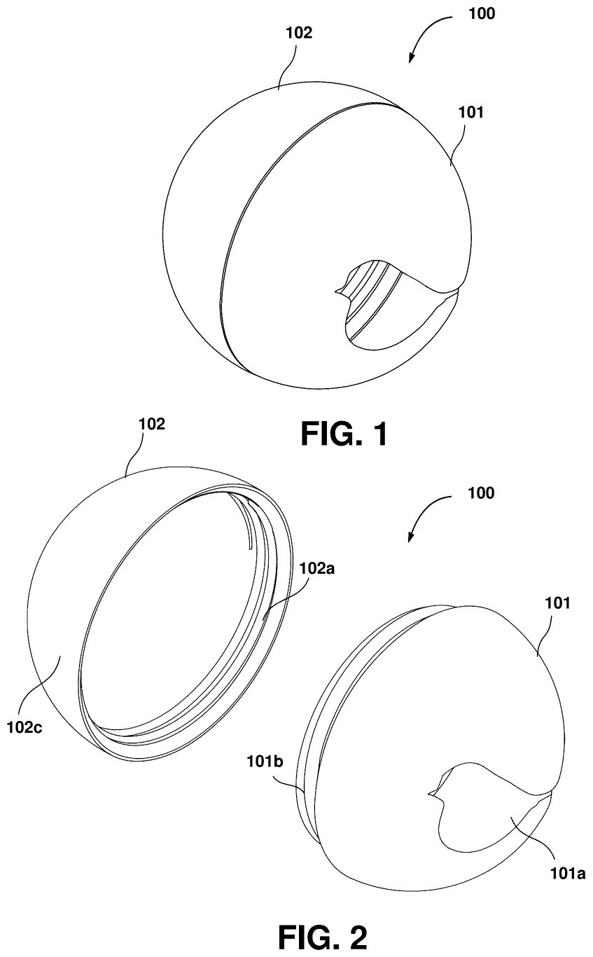

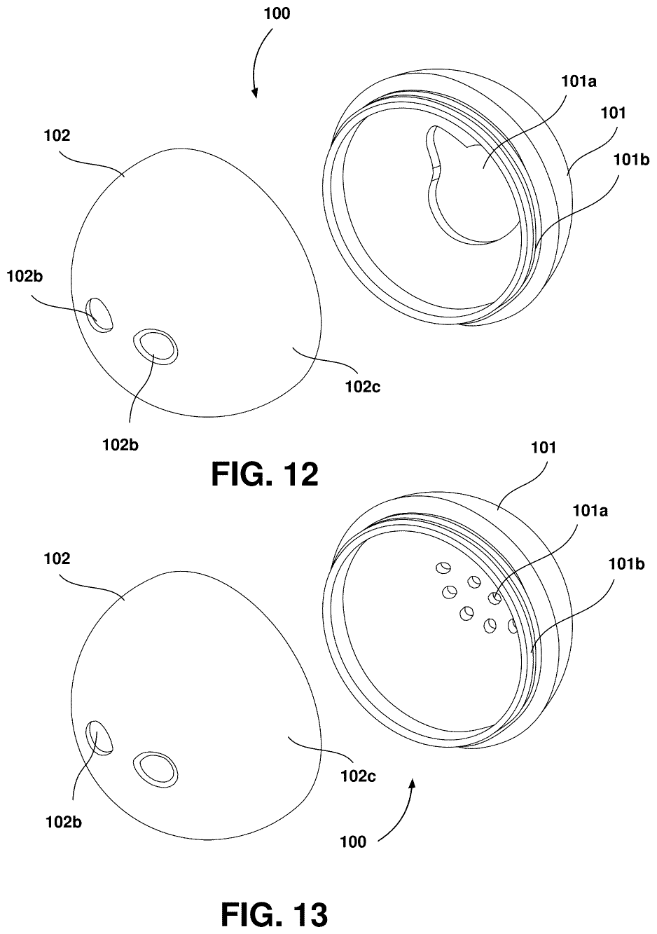

Referring to FIGS. 1-18, the ball-shaped 100 or pet interactive wand toy 200 is illustrated in accordance with various example embodiments the present disclosure. Referring particularly to FIGS. 1-9, a pet treat feeder 100 is configured in a ball shape or spheroid shape and is illustrated in accordance with multiple examples of the present disclosure.

As shown in FIGS. 1-2 and 7, the ball-shaped pet treat feeder 100 includes a first hollow member 102, and a second hollow member 101. The two hollow members 102,101 are openably attachable to form the ball-shaped feeder 100 for holding pet food (treats) and/or attractants (such as catnips or similar herbs). In the example shown, the first hollow member 102 includes one or more inner male threads 102a that rotatably engage with one or more inner female threads 101b of the second hollow member to attach or couple two hollow members 102,101. Although the two hollow members 102,101 are shown to removably attach using the two sets of threads 102b,101b, it should be understood that the two hollow members 102,101 may be removably coupled or openably coupled using other attachment mechanisms for example but not limited to snap fit mechanism, using one or more fasteners (such as screws). In another embodiment, the two hollow members 102,101 may be openably coupled using hinges, or clasps or equivalents.

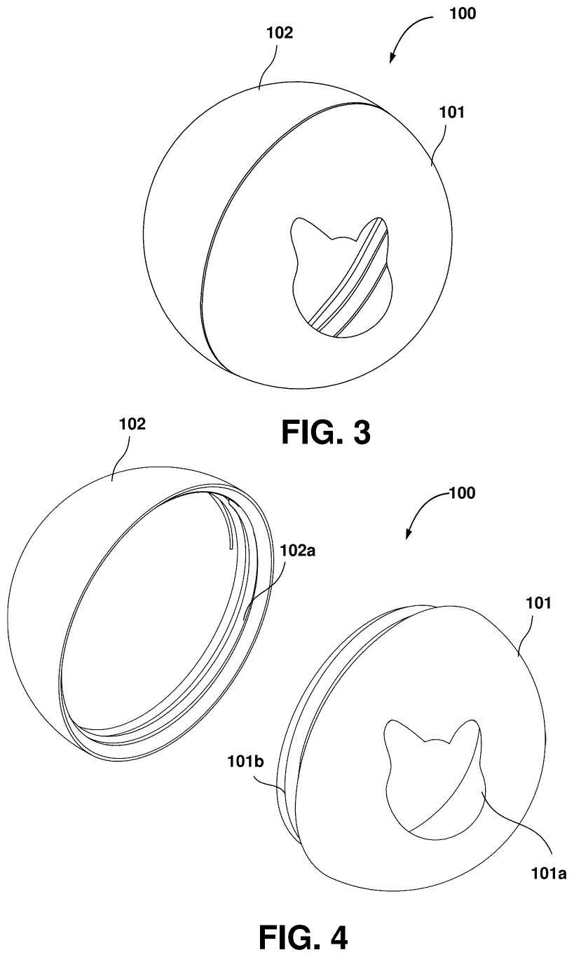

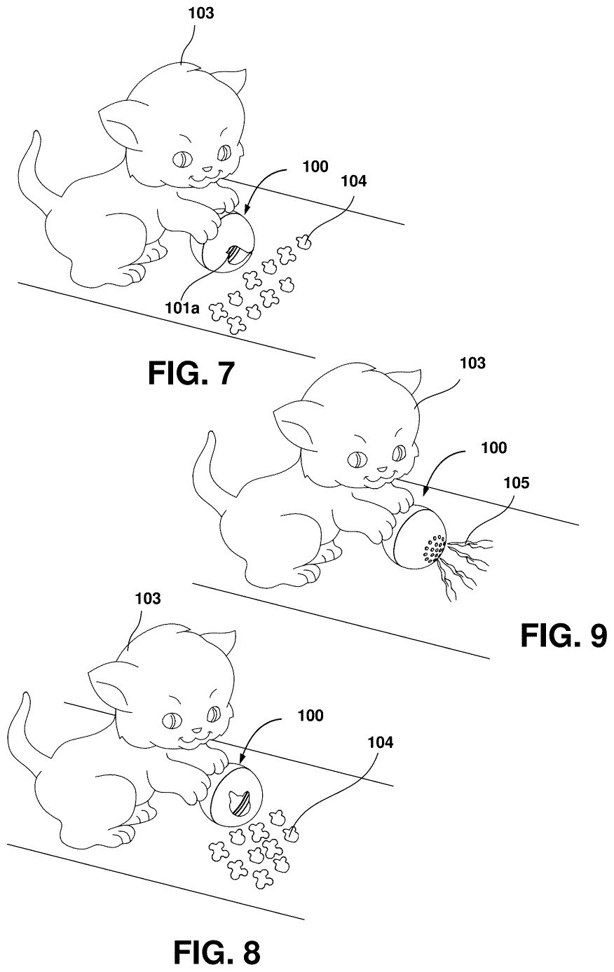

Additionally, the example embodiment shown in FIGS. 1-2 is configured for holding the pet treats 104. As seen in FIGS. 1-2, the hollow member 101 includes the opening 101a for dispensing the treats 104. The at least one opening 101a invokes a cat-related imagery. In this example embodiment, the opening 101a is bird-shaped opening. The pet treat feeder 100 may be rolled along a surface (floor, for example) by a pet 103 playing with the ball 100 and/or a pet owner. The pet 103 can actively play with the pet treat feeder 100 and in turn, be rewarded with the treats 104 as seen in FIG. 7. The pet treat feeder 100 not only keeps the pet 103 engaged but also fulfils pet's hunger. The size and shape of the opening 101a is chosen such that it attracts the pet 103 and at the same time comfortably dispense the treats 104 in a controlled manner.

FIGS. 3-4, 8 shows the pet treat feeder 100 according to another embodiment or variation. Essentially, the pet treat feeder 100 shown in FIGS. 3-4 is identical to the pet treat feeder 100 shown in FIGS. 1-2 except the size and shape of the opening 101a located on the hollow member 101. Specifically, in this embodiment, the opening 101a is cat head shaped opening. The size and shape of the opening 101a in this embodiment is larger compared to the opening 101a shown in FIGS. 1-2. Like FIG. 7, the pet treat feeder 100 may be rolled along a surface (floor for example) by the pet 103 playing with the ball 100 and/or a pet owner. The pet 103 can actively play with the pet treat feeder 100 and in turn be rewarded with the treats 104 as seen in FIG. 8.

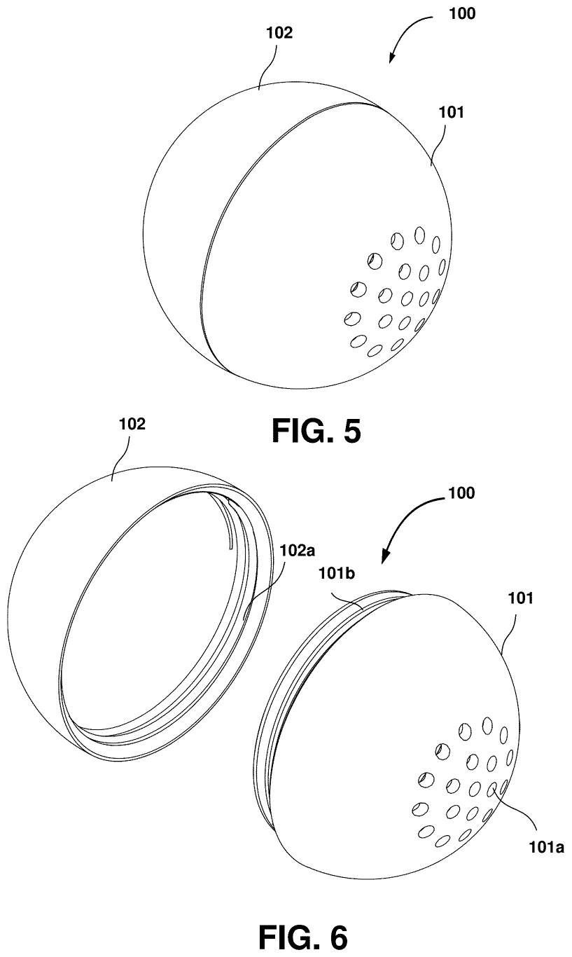

FIGS. 5-6, 9 shows the pet treat feeder 100 or specifically catnip or similar herb holding ball 100, according to another embodiment. Essentially, the pet treat feeder 100 shown in FIGS. 5-6 is identical to the pet treat feeder 100 shown in FIGS. 1-4 except the size and shape of the opening 101a located on the hollow member 101. Specifically, in this embodiment, the opening 101a is not a single opening, rather includes multiple tiny openings or tiny holes. The openings 101a may be oriented in a specific pattern or randomized pattern. In the example shown, a single opening is surrounded by multiple openings arranged to surround the centrally located opening. Since in this embodiment, the pet treat feeder 100 is meant to hold attractant such as catnip or similar herbs that releases aroma to attract the pets specially cats, the holes 101a are kept substantially tiny enough to only be able to release the aroma or scent and prevent falling out any herbs loaded inside the pet treat feeder 100. Similar to FIG. 7 or FIG. 8, the spherical ball 100 may be rolled along a surface by the pet 103 playing with the pet treat feeder 100 who may be attracted by the released aroma or scent from the openings 101a. The pet 103 can actively engage and play with the pet treat feeder 100.

Although the two semi-spherical hollow members 102,101 in FIGS. 3-6 are shown to attach using the two sets of threads 102b,101b, it should be understood that the two semi-spherical hollow members 102,101 may be removably or openably coupled using other attachment mechanisms for example but not limited to snap fit mechanism, using one or more fasteners (such as screws), hinges, clasps.

The embodiment of the invention described and shown in FIGS. 1-6 involves only pet treat feeder 100 that the pet 103 can play with rolling on the surface or floor. Another embodiment of the interactive wand toy utilizing the spherical ball 100 can be envisioned by connecting the spherical ball 100 (of FIGS. 1-6) to a wand to form an interactive play toy commonly referred to as “interactive wand toy 200” or ”pet interactive wand toy 200”. The wand may be a thin, lightweight rod that can be held with one hand and be made of different materials for example, wood, metal, bone, or stone. The wand may be cylindrical in shape, a parallelepiped shape or other elongated shape.

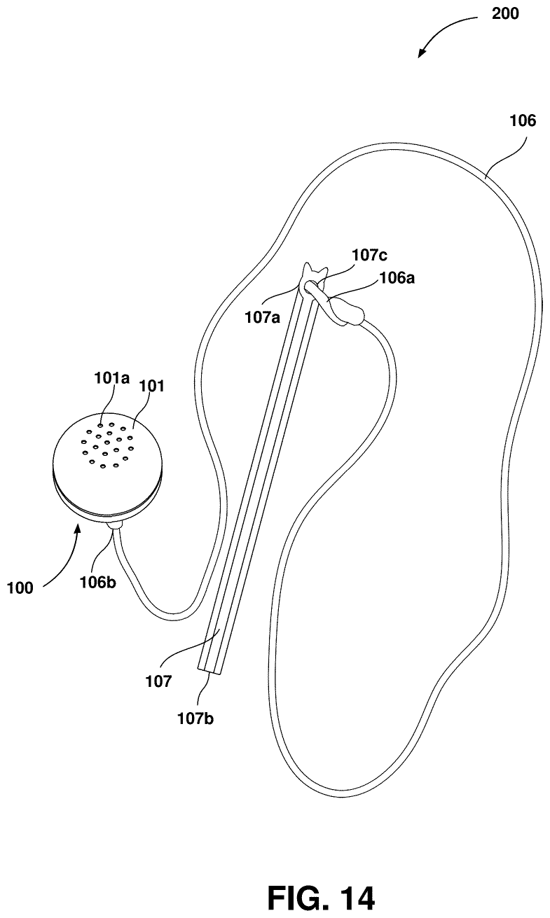

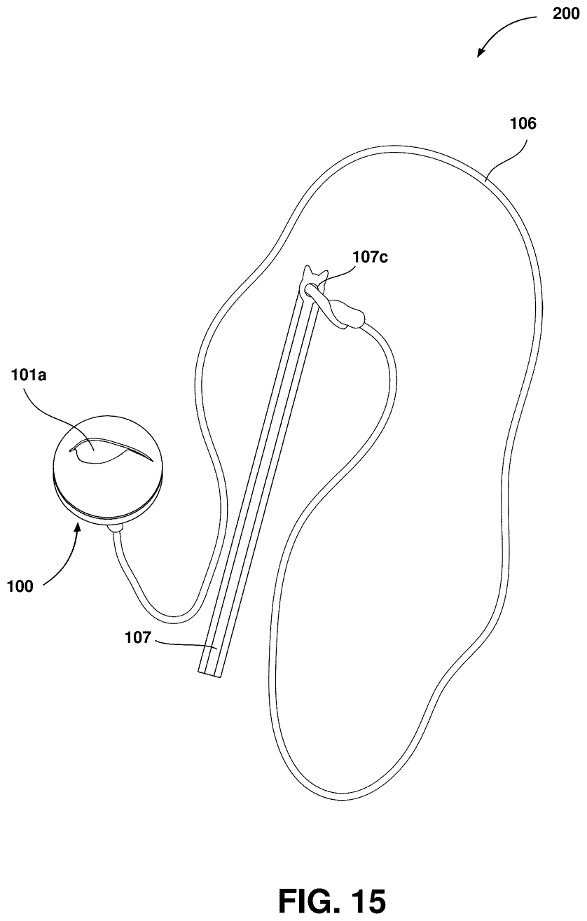

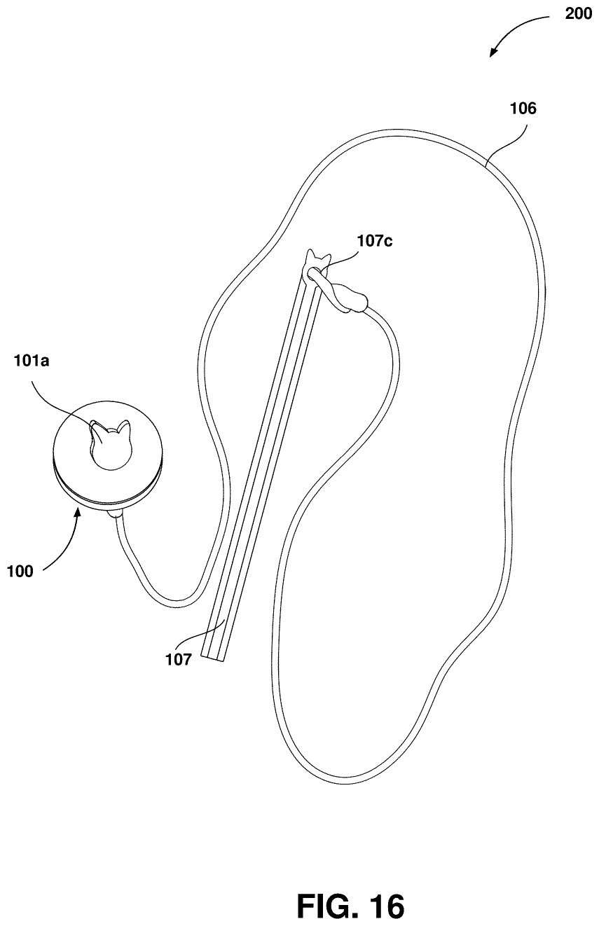

In the interactive wand toy configuration shown in FIGS. 14-16, the pet treat feeder 100 of FIGS. 1, 3, 5 is connected to a wand 107 using a cord 106. The wand 107 can be held by a pet owner 108 to move the ball 100 randomly in different directions like forward, backward, and sidewise, for example. For clarity of disclosure, the terms “backward”, “forward”, and “sidewise: are defined herein relative to the pet owner holding the wand. The term “backward” refers to a direction behind the wand, toward the pet owner holding the wand. The term “forward” refers to a direction in front of the wand, away from the pet owner holding the wand. The term “sidewise” refers to a direction in the sides of the wand, away from the pet owner holding the wand.

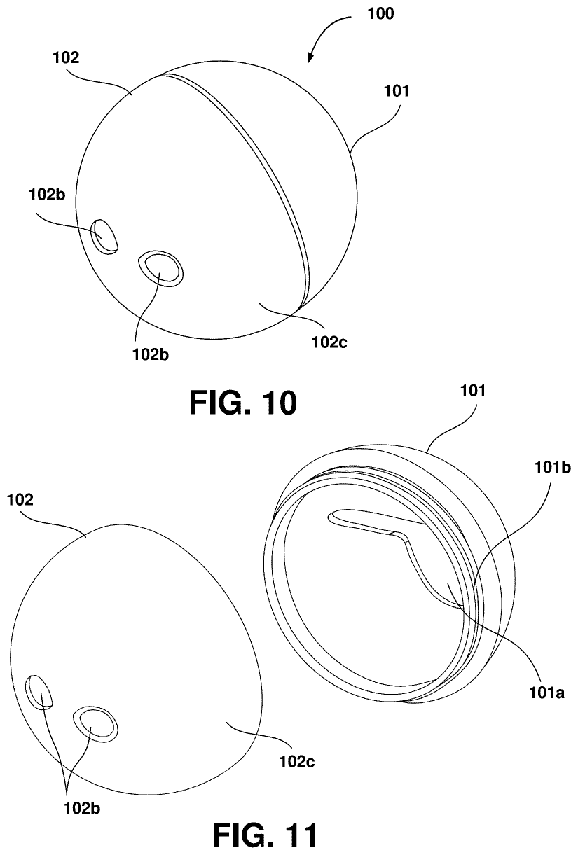

With reference to FIGS. 14-16, the pet treat feeder 100 of FIGS. 1, 3, 5 (is modified as shown in FIGS. 10-13) and shown connected to the wand 107 with a first end 107a, and a second end 107b using a cord 106 having a proximal end 106a, and a distal end 106b. The proximal end 106a of the cord 106 is coupled (forming a knot) to a loop 107c formed at the first end 107a of the wand 107 and the distal end 106b of the cord 106 is coupled to the cord engagement provision 102b located on the first semi-spherical hollow member 102.

For this purpose, the hollow member 102 is shown to include a cord engagement provision 102b located on an exterior surface 102c at the center of the hollow member 102. In an example embodiment, the cord engagement provision 102b is configured as a pair of slots 102b that internally interconnect to allow an end of the cord 106 to loop through to form a knot. However, it should be understood that other configurations for the cord engagement provision 102b may be possible, for example, instead of the pair of slots 102b, it may be possible to have a round hook (Eg. item no. HBAM20 from Litetronics®) screwed on the hollow member 102. Also, in some embodiments, the loop 107c formed at the first end 107a of the wand 107 may be substituted with other provisions. For example, the end 107a may have round hook (Eg. item no. HBAM20 from Litetronics®) screwed on the end 107a. In another embodiment, the end of the cord 106a may be directly coupled to the end 107a of the wand 107 forming a knot.

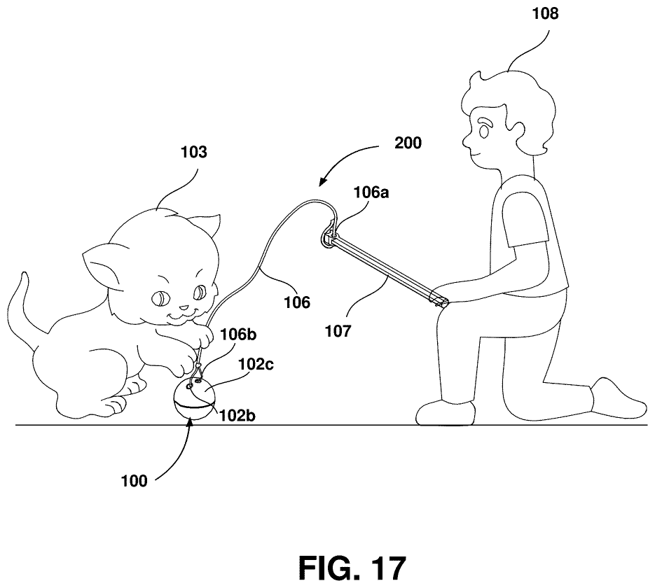

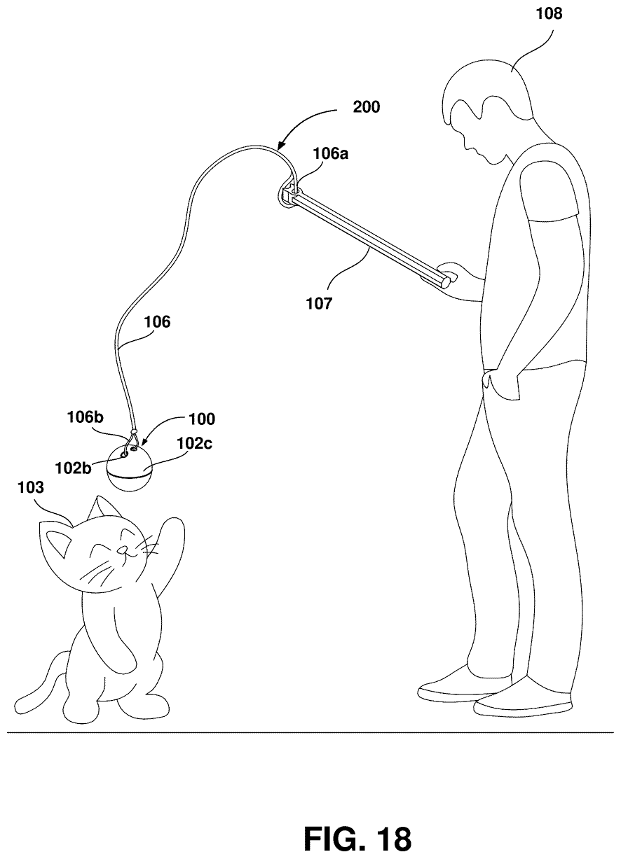

In the configuration shown in FIGS. 14-16 and FIGS. 17-18, when a pet owner 108 holds the wand 107 of the pet interactive wand toy 200, the pet treat feeder 100 of FIGS. 11-13 may hang or dangle, via the cord 106, from the wand 107 of the pet interactive wand toy 200. In this configuration, as shown in FIGS. 17-18, the pet owner 108 holding the wand 107 may dangle the feeder 100 (holding pet treats or attractant) in front of the pet 103. The pet owner 108 is able to move the ball 100 forward, backward, or sidewise, enticing the pet 103 to bat at or otherwise play with the feeder 100.

The wand toy 200 that features the feeder 100 attracts a combination of the pet's (cat's) senses and quickly entices the pet to play. The treat feeder 100 and interactive wand toy 200 design according to the present disclosure may provide a dynamic playing experience including multiple playing functionalities capable of capturing and holding the attention of pets for longer periods of time.

Finally, while the present invention has been described above with reference to various exemplary embodiments, many changes, combinations, and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

1. A ball-shaped pet treat feeder (100) and interactive wand toy (200), comprising:
a first hollow member (102);
a second hollow member (101) openably attachable to the first hollow member (102) to form the ball-shaped pet treat feeder (100) capable of holding at least pet treats (104), or attractants therein; and
wherein, the second hollow member (101) comprising at least one opening (101a) to facilitate at least one of: random dropping of the pet treats (104) or releasing aroma from the attractants placed inside the ball-shaped pet treat feeder (100) as the ball-shaped pet treat feeder (100) is rolled along a surface by a pet (103) and/or a pet owner (108) or swung on the air by the pet owner (108); and
wherein, the first hollow member (102) comprises a cord engagement provision (102b) adapted for releasably connecting the ball-shaped pet treat feeder (100) to a wand (107) such that the pet owner (108) can interactively play with the pet (103) holding the wand (107).

2. The ball-shaped pet treat feeder (100) and interactive wand toy (200) of claim 1, wherein the first hollow member (102) comprises one or more inner male threads (102a) that rotatably engages with one or more inner female threads (101b) of the second hollow member (101) to attach them together.

3. The ball-shaped pet treat feeder (100) and interactive wand toy (200) of claim 1, wherein the wand (107) comprising a first end (107a) with a loop (107c), and a second end (107b).

4. The ball-shaped pet treat feeder (100) and interactive wand toy (200) of claim 1 further comprising a cord (106) with a proximal end (106a), and a distal end (106b).

5. The ball-shaped pet treat feeder (100) and interactive wand toy (200) of claim 4, wherein the proximal end (106a) of the cord (106) is coupled to a loop (107c) at the first end (107a) of the wand (107) and the distal end (106b) of the cord (106) is coupled to the cord engagement provision (102b) located on the first hollow member (102).

6. The ball-shaped pet treat feeder (100) and interactive wand toy (200) of claim 1, wherein the cord engagement provision (102b) is located at an exterior surface (102c) and at the center of the first hollow member (102).

7. The ball-shaped pet treat feeder (100) and interactive wand toy (200) of claim 1, wherein the at least one opening (101a) is a cat-related imagery.

8. The ball-shaped pet treat feeder (100) and interactive wand toy (200) of claim 7, wherein the cat-related imagery is at least a cat head shaped opening, a bird shaped opening, or a circular opening capable of dispensing the pet treats (104) at different rates.

9. The ball-shaped pet treat feeder (100) and interactive wand toy (200) of claim 1, wherein the at least one opening (101a) is chosen to result in variable dispensing rates for the pet treats (104) held within the ball-shaped pet treat feeder (100).

10. The ball-shaped pet treat feeder (100) and interactive wand toy (200) of claim 1, wherein the at least one opening (101a) comprises a plurality of tiny holes for releasing aroma from the attractants placed inside the ball-shaped pet treat feeder (100) and restricting the dispensing of the attractants therethrough.

11. The ball-shaped pet treat feeder (100) and interactive wand toy (200) of claim 1, wherein the second hollow member (101) is openably attachable to the first hollow member (102) using at least a snap-fit mechanism, fasteners, one or more clasps, hinge mechanism.

12. The ball-shaped pet treat feeder (100) and interactive wand toy (200) of claim 1, wherein the attractants comprises catnips or herbs.

13. An interactive pet wand toy (200), comprising:
a ball-shaped pet treat feeder (100) comprising:
a first hollow member (102);
a second hollow member (101) openably attachable to the first hollow member (102) and comprising at least one opening (101a);
a wand (107) comprising a first end (107a), and a second end (107b);
a cord (106) with a proximal end (106a), and a distal end (106b), wherein, the proximal end (106a) of the cord (106) is coupled to the first end (107a) of the wand (107) and the distal end (106b) of the cord (106) is coupled to a cord engagement provision (102b) located on the first hollow member (102); and
wherein, the at least one opening (101a) facilitates at least one of: random dropping of pet treats (104) or releasing aroma from attractants placed inside the ball-shaped pet treat feeder (100) as the ball-shaped pet treat feeder (100) is rolled along a surface by a cat (103) or swung on the air by a pet owner (108) grasping the wand (107).

14. The ball-shaped pet treat feeder (100) and interactive wand toy (200) of claim 13, wherein the second hollow member (101) is openably attachable to the first hollow member (102) using at least a set of male and female threads configured on the second hollow member (101) and first hollow member (102), a snap-fit mechanism, fasteners, one or more clasps, hinge mechanism.

15. The ball-shaped pet treat feeder (100) and interactive wand toy (200) of claim 13, wherein the cord engagement provision (102b) is located at an exterior surface (102c) and at the center of the first hollow member (102).

16. The ball-shaped pet treat feeder (100) and interactive wand toy (200) of claim 13, wherein the at least one opening (101a) is a cat-related imagery including at least a cat head shaped opening, a bird shaped opening, or a circular.

17. The ball-shaped pet treat feeder (100) and interactive wand toy (200) of claim 13, wherein the at least one opening (101a) is chosen in shape and size such as to result in variable dispensing rates for the pet treats (104) held within the ball-shaped pet treat feeder (100).

18. The ball-shaped pet treat feeder (100) and interactive wand toy (200) of claim 13, wherein the at least one opening (101a) comprises a plurality of tiny holes for releasing aroma from the attractants placed inside the ball-shaped pet treat feeder (100) and restricting the dispensing of the attractants.

19. The ball-shaped pet treat feeder (100) and interactive wand toy (200) of claim 13, wherein the cord engagement provision (102b) comprises a pair of slots (102b) formed at the first hollow member (102) to allow the distal end (106b) of the cord (106) to loop through to form a knot.

20. (canceled)

21. (canceled)

22. (canceled)

23. (canceled)
